(19) United States
(12) Patent Application Publication
(10) Pub. No.: US 2011/0101681 A1
(43) Pub. Date: May 5, 2011

(54) COUPLING MEMBER WITH INTERRUPTED THREAD AND METHOD OF MANUFACTURE

(75) Inventor: Timothy James O'CONNOR, Eden, NY (US)

(73) Assignee: Tekni-Plex, Inc., King of Prussia, PA (US)

(21) Appl. No.: 12/917,047

(22) Filed: Nov. 1, 2010

Related U.S. Application Data
(60) Provisional application No. 61/257,075, filed on Nov. 2, 2009.

(51) Int. Cl. F16L 33/00; B23P 17/00

(52) U.S. Cl. 285/259; 29/890.14

(57) ABSTRACT

Coupling assembly for use in conduits or tubing holding a pressurized liquid, such as a garden hose. The structure provided facilitates uncoupling of male and female fittings in such an assembly which substantially reduces the uncontrolled release of pressure in the system such that the pressurized liquid will not flow uncontrollably from the assembly during decoupling. Methods are provided for making and using such components that result in one or more of an ease of manufacture, reduced material costs, reduced machining costs, and/or ease of use.

### FIELD OF THE INVENTION

The present invention relates to coupling members, such as male and female fittings for coupling the end of a garden hose to a nozzle, and more specifically to an apparatus and method for facilitating the uncoupling of such members and for the manufacture thereof.

### BACKGROUND

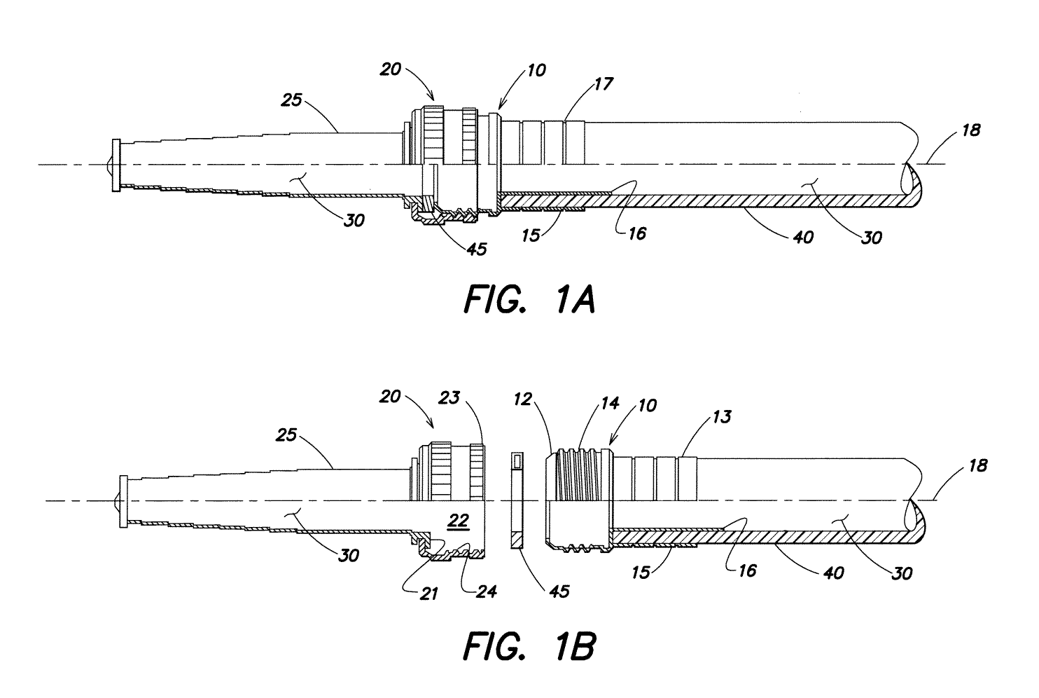

Conventional coupling members such as those attached to the end of a garden hose have not changed greatly over the years. As illustrated in FIGS. 1a (assembled view) and 1b (exploded view), the typical prior art male coupling member or fitting 10 is a substantially cylindrical metallic body, e.g. made of brass. At its distal end 12 is an external continuous male thread 14 for attachment to a continuous internal female thread 24 on a female coupling member or fitting 20, here shown as part of a nozzle 25. An aligned bore 30 extends longitudinally (along axis 18) through the male fitting and female fitting. At the proximal end 13 of the male fitting is a connector comprising spaced-apart inner and outer concentric walls 15, 16 sized and shaped to retain the distal end of a garden hose 40. The outer surface 17 of the proximal end may be grooved or otherwise provide a surface adapted to the gripped by the user, during coupling and uncoupling of the male and female fittings. A separate washer element 45 is disposed between the distal end of the male fitting and an end wall 21 of an interior bore or chamber 22 at the proximal end 23 of the female fitting. The washer enhances the formation of a seal (along with the continuous full threads) between the male and female fittings to prevent leakage of pressurized water while the nozzle is in use. However, during disassembly or uncoupling of the male and female fittings, e.g., by unthreading the male and female threads, it is only the threads that provide a seal. As almost everyone has experienced if they have attempted to unthread a nozzle from a hose when the water has not been turned off at the spigot, these continuous full threads provide a very poor sealing mechanism during disassembly and the result is that water is sprayed uncontrollably in every direction, including all over the person attempting the disassembly.

In other environments, interrupted threads have been used between male and female coupling members for other purposes. For example, prior art carbonated beverage closures utilize interrupted threads for the purpose of slowly releasing gas pressure in the head space so the cap does not fly off the container and injure the consumer or someone standing nearby. See for example U.S. Pat. No. 4,948,001.

In another application, prior art tamper-evident and/or child-resistant plastic containers (e.g., for pharmaceuticals) provide a snap-on closure with interrupted threads. The cap is applied with a downward snap-on motion enabled by the interrupted threads. See U.S. Pat. No. 5,967,352. In another example, the interrupted threads may be utilized to disengage a locking member such as a barb, allowing a push-down motion to disengage and allow rotation of the cap for removal. See U.S. Pat. No. 7,331,479. In both of these examples, the snap-on closures are enabled by the interrupted threads.

A further example of a prior art snap-on coupling with interrupted threads is for connection of multiple pipe segment ends to facilitate their assembly and disassembly, i.e. less rotation is required as only a small partial turn of the interrupted threads is required for coupling or decoupling. See U.S. Pat. No. 7,513,537.

However, none of these prior art interrupted thread structures have been designed or recommended for use in an assembly in which a pressurized liquid is contained within a coupling assembly, during a disassembly process, as utilized in the present invention.

There is a recognized and long-felt need for an improved method of decoupling male and female fittings, such as for use with a garden hose, wherein the assembly is utilized with a pressurized liquid.

### SUMMARY OF THE INVENTION

According to one embodiment of the invention, a new coupling assembly is provided for use in conduits or tubing holding a pressurized liquid, such as a garden hose. In accordance with the invention, a new structure is provided which facilitates uncoupling of male and female fittings in such an assembly which substantially reduces the uncontrolled release of pressure in the system such that the pressurized liquid will not flow uncontrollably from the assembly during decoupling.

In another embodiment of the invention, methods are provided for making and using such components that result in one or more of an ease of manufacture, reduced material costs, reduced machining costs, and/or ease of use.

According to one embodiment of the invention, a hose coupling assembly is provided comprising:
a generally cylindrical male fitting having a first end connector for attachment to a garden-type hose or spigot and a second end connector having a plurality of interrupted, male thread portions for attachment to a female fitting, a plurality of longitudinally disposed channels each extending across the plurality of male thread portions;
a female fitting having a female thread disposed within a chamber adjacent a first end of the female fitting for coupling to the second end connector of the male fitting, the chamber having an end wall;
a movable sealing member sized to fit between the second end of the male fitting and the end wall of the female fitting and extend across the channels;
an aligned central longitudinal bore in the male and female fittings and sealing member to allow a pressurized liquid to flow through the bore;
wherein the sealing member is movable between positions:
   a first position engaging both the end wall of the female fitting and second end of the male fitting to seal the assembly against leakage of the pressurized liquid when the male and female fittings are fully coupled;
   a second position spaced from each of the end wall and second end upon initial decoupling of the male and female fittings, wherein the pressurized liquid can flow into the channels to reduce the pressure of the liquid in the assembly; and
   a third position spaced from the end wall and engaging the second end of the male fitting to seal the channels against flow of the pressurized liquid during subsequent decoupling.

In one embodiment, the female fitting comprises a nozzle, hose, sprinkler or spigot.

In one embodiment, the garden-type hose is a water hose for residential or commercial use operating at pressures of a municipal water line.

In one embodiment, the pressure comprises 30 to 60 pounds per square inch.

In one embodiment, the hose has a diameter of ⅜ to one inch.

In one embodiment, the male fitting is made of metal.

In one embodiment, the metal is brass or aluminum.

In one embodiment, the male and female fittings are each independently made of metal or plastic.

In one embodiment, the male and female fittings are both made of metal.

In one embodiment, the metal is brass.

In one embodiment, the movable sealing member comprises a resilient plastic or rubber type compound.

According to another embodiment of the invention, a coupling assembly is provided comprising:
male and female fittings having an aligned longitudinal bore for conveying a pressurized liquid,
the fittings having male and female threads respectively, the male thread having interrupted thread portions and longitudinal channels extending across the thread portions;
a movable sealing member closing the channels when the fittings are fully coupled;
the sealing member being movable during an initial decoupling to open the channels for a partial pressure relief and flow of the liquid into the channels; and
subsequent to the initial decoupling, the sealing member being movable to a further resealing position closing the channels to block the flow of the liquid during further decoupling.

In one embodiment, the fittings are adapted for one or more of a plumbing, water heater, propane or natural gas tank, fuel system or coolant system.

In one embodiment, the fittings are adapted for conveyance of a pressurized liquid at up to about 80 pounds per square inch of pressure.

In one embodiment, the pressure is about 30 to 60 pounds per square inch.

In one embodiment, the fittings are garden hose type fittings.

According to another embodiment of the invention, a method of making a fitting is provided comprising:
providing a generally cylindrical bar having a longitudinal axis for forming a plurality of fittings;
extruding the bar through a splined extrusion die to form a splined bar having longitudinal projections separated by longitudinal channels;
forming a plurality of fittings from the splined bar including steps of, in either order:
   cutting the bar transverse to its length to form the plurality of fittings; machining or milling a plurality of interrupted thread portions adjacent one end of each fitting, wherein the channels of the splined bar comprise longitudinally disposed channels extending across the plurality of thread portions.

In one embodiment, the bar comprises metal or plastic.

In one embodiment, the bar comprises brass or aluminum.

In one embodiment, the bar comprises a solid cylindrical bar and the method further comprises the step of forming a central longitudinal bore in the bar.

In one embodiment, the central longitudinal bore is formed during the extrusion step.

In one embodiment, the bar has a central longitudinal bore.

In one embodiment, the fitting comprises a coupling member for a tube conducting a pressurized liquid.

In one embodiment, the tube conveys a liquid at up to about 80 pounds per square inch of pressure.

In one embodiment, the tube conveys a liquid at a pressure of a municipal water line.

In one embodiment, the pressure is a In one embodiment, bout 30 to 60 pounds per square inch.

In one embodiment, the fitting comprises a metallic fitting for a garden-type hose, nozzle, sprinkler or spigot.

In one embodiment, the hose has a diameter in the range of ⅜ to one inch.

In one embodiment, the fitting comprises a gas grill fitting or a plumbing fitting.

In one embodiment, the fitting comprises a sink fitting, a toilet fitting or a hot water heater fitting.

In one embodiment, fitting comprises a male or female fitting.

In one embodiment, the fitting comprises a male fitting.

### DETAILED DESCRIPTION OF THE FIGURES

FIG. 1A is a side, elevational and partial sectional view of the distal end of a garden hose coupled to a nozzle, as known in the prior art, while FIG. 1B is a disassembled view of the same coupling apparatus of FIG. 1A;

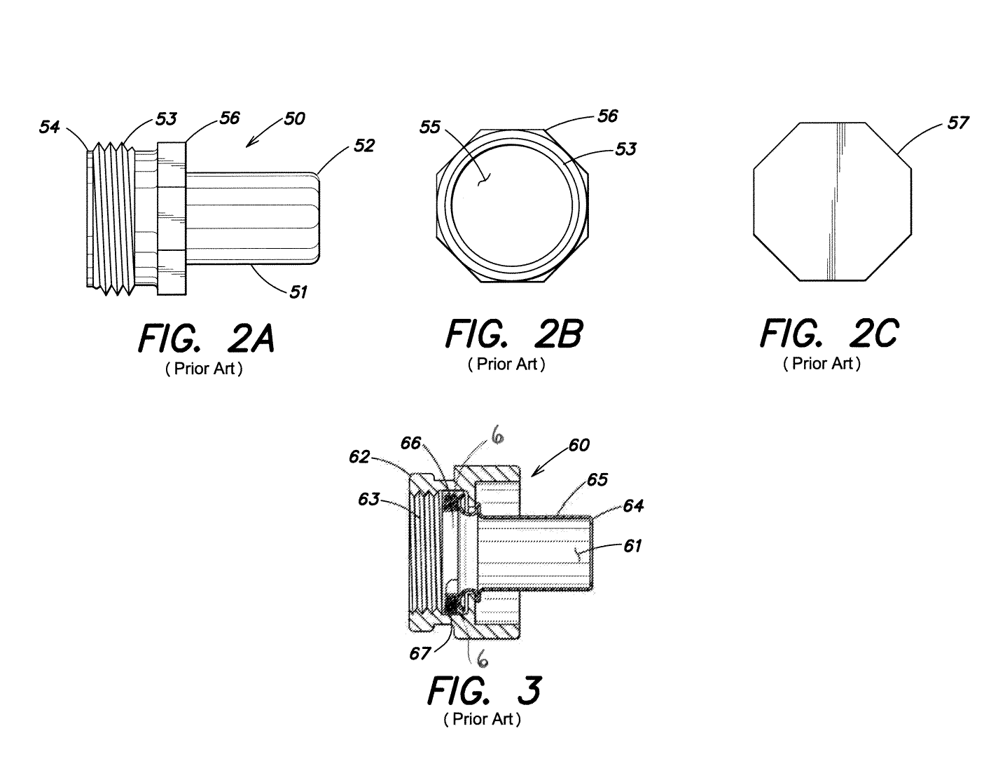

FIG. 2 shows various views of a prior art male fitting with a continuous full external thread, FIG. 2A being a side, elevational view of the male fitting, FIG. 2B a distal end view, and FIG. 2C a schematic illustration of an octagonal shaped extruded bar from which the male fitting has been manufactured;

FIG. 3 is a side, cross-sectional view of a prior art female fitting with a continuous full internal thread, for use with the male fitting of FIG. 2;

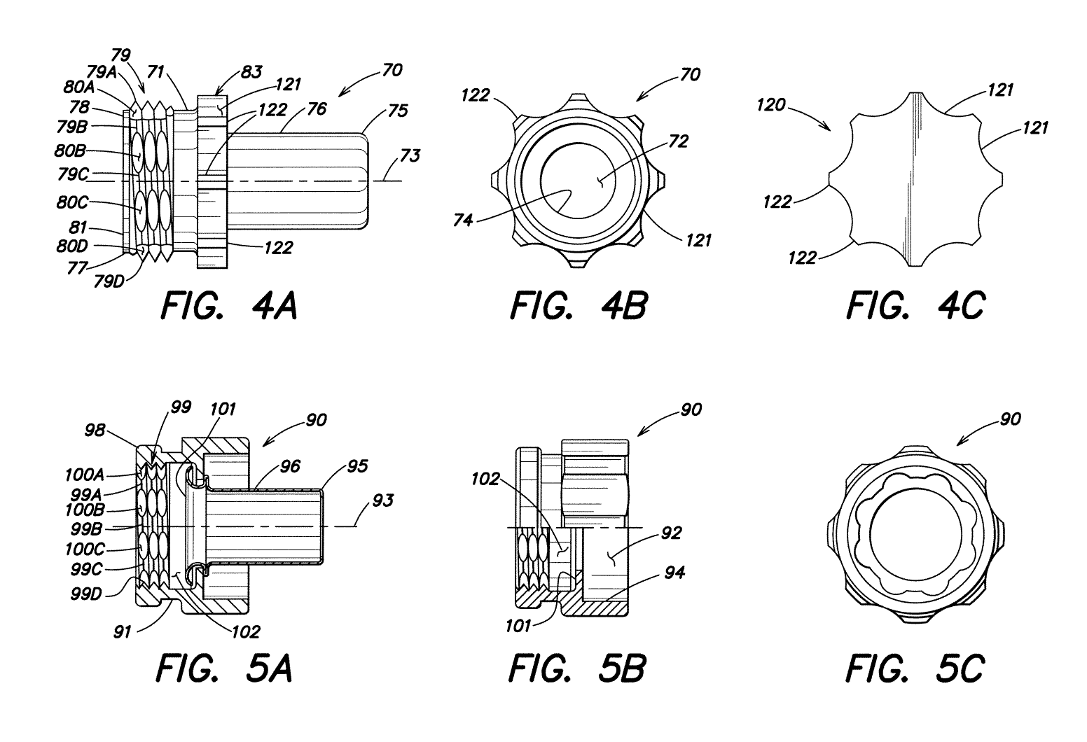

FIG. 4 illustrates various views of one embodiment of the invention, FIG. 4A being a side, elevational and partial sectional view of a male fitting having an interrupted external thread, FIG. 4B being a distal end view of the male fitting, and FIG. 4C being an extruded grooved (splined) shaped bar from which the male fitting may be manufactured;

FIG. 5 illustrates various views of a female fitting according to another embodiment of the invention, FIG. 5A being a side, cross-sectional view of the female coupling member, FIG. 5B a partial cross-sectional view of the same fitting and FIG. 5C a proximal end view of the female fitting;

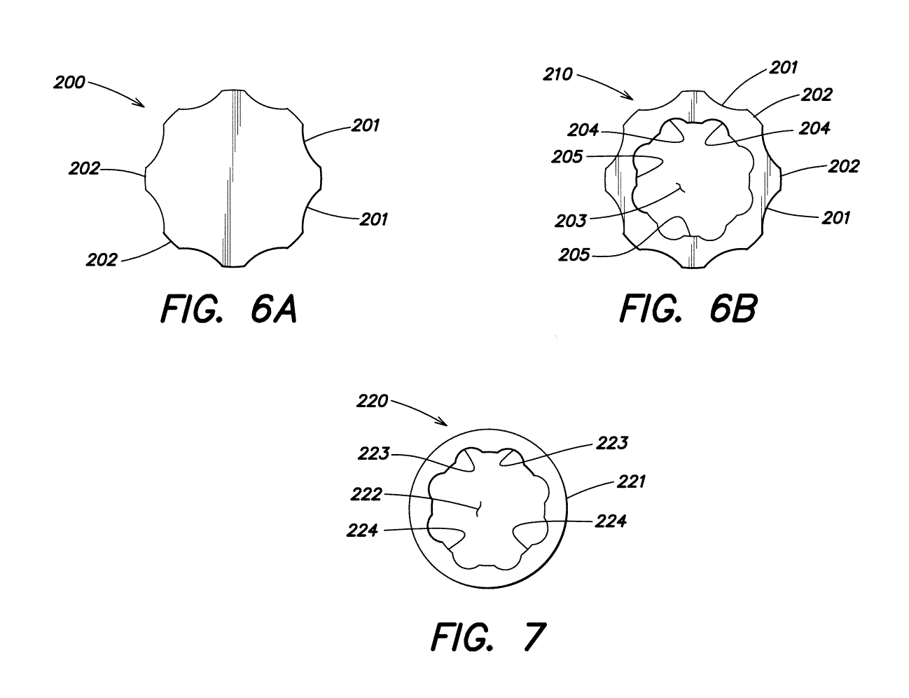

FIG. 6 illustrates two embodiments of a component for making a fitting according to one embodiment of the present invention, FIG. 6A being an end view of a solid extruded exterior spline shaped bar, similar to FIG. 4C, for making a male fitting, and FIG. 6B being a hollow extrusion having the same exterior shape as FIG. 6A, but with an interior extruded central bore having an internal spline shape for use in manufacturing a female fitting similar to FIG. 5C;

FIG. 7 is an end view of an alternative bar shape having a cylindrical outer surface and a recessed (splined) inner surface similar to FIG. 6B;

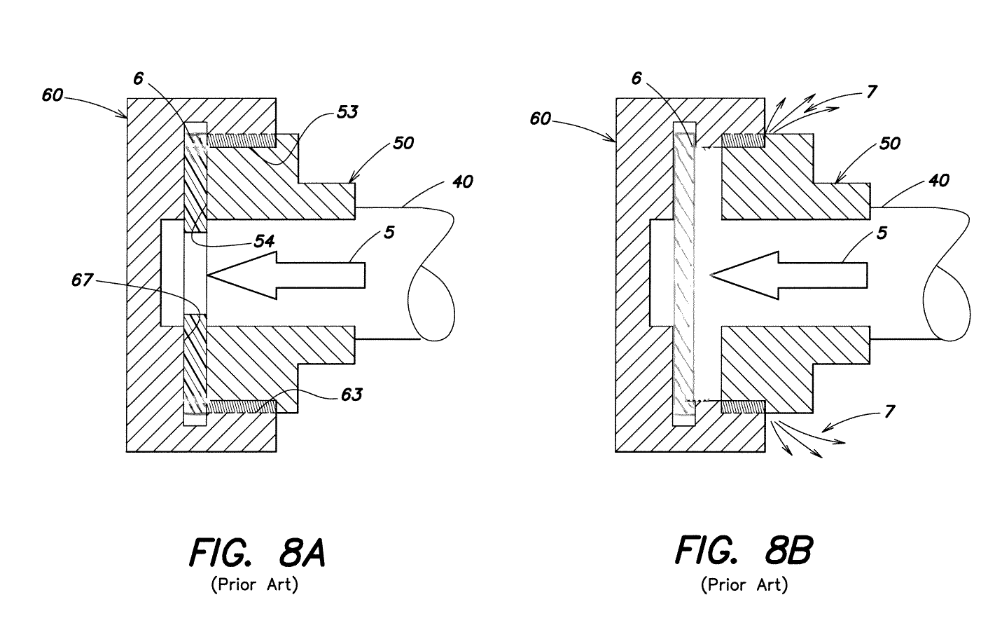

FIG. 8 illustrates schematically the uncontrolled spraying problem of the prior art full thread coupling assembly, FIG. 8A showing the male and female fittings fully coupled, and FIG. 8B the uncontrolled liquid spray during decoupling;

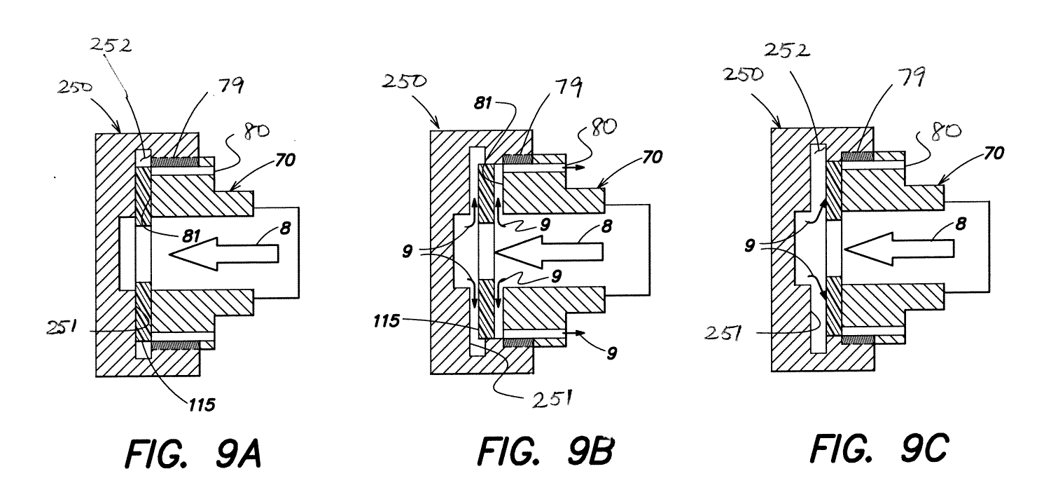

FIG. 9 illustrates schematically, according to one embodiment of the invention, the movement of a sealing element between male and female fittings during decoupling to provide a controlled release of pressure and fluid flow according to one embodiment of the invention, FIG. 9A showing the male and female fittings fully engaged, FIG. 9B during the initial decoupling, and FIG. 9C after the initial decoupling with the sealing member reengaged with the male fitting; and

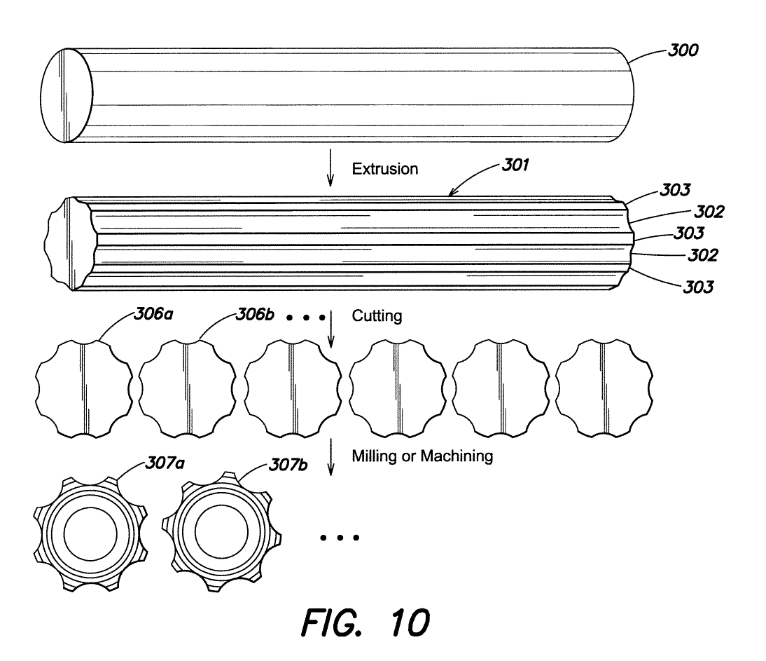

FIG. 10 is a schematic view of a manufacturing process according to one embodiment of the invention.

### DETAILED DESCRIPTION

In one embodiment, a male coupling member (fitting) of the present invention can either be adapted for attachment to the end of a hose, such as a garden hose, or it can comprise the outer end of a tap or faucet to which a garden hose is to be attached. When the male coupling member is permanently attached to the end of a hose, it may be releasably attached to a corresponding female coupling member which is part of another hose segment, a nozzle, a lawn sprinkler, or spigot, or the like. The female coupling members according to various embodiments can alternatively be permanently attached to the end of a hose, or to a hose segment, and/or releasably attached to a male coupling member of another hose segment, or to a male coupling member at the end of a tap or faucet.

Throughout this application, the term “thread portions” refers to the fact that a standard thread is, in fact, a continuous full helical thread extending around a cylindrical surface. Thus, each turn of the thread may pass adjacent to a prior turn, but remains an extension of the same. Therefore, the term “thread portions” is meant to refer to and include each turn of the thread in a continuous thread. When this application refers to “interrupted thread” or “interrupted thread portions,” this is meant to refer to an interruption in the continuity or continuous nature of a thread in one such thread turn. Therefore, when this application refers to an interruption or channel which extends longitudinally across each of a plurality of interrupted thread portions, this refers to a continuous interruption across all of the thread turns on either a male or female member.

As a reference point, FIGS. 2-3 show in greater detail a prior art male and female fitting pair each having a full continuous thread, without interruptions. The male fitting 50 is a substantially cylindrical metal body having a central through bore 55, having a hose connector 51 adjacent a proximal end 52, and a continuous thread 53 adjacent a distal end 54. Between the proximal and distal ends is an external grip 56, here shown as an octagonal shaped enlarged diameter portion on the exterior of the fitting. FIG. 2C shows an end view of an extruded bar 57 of octagonal cross section used to manufacture the prior art male fitting having an octagonal grip. The disadvantages of this prior art process, as distinguished from that of the present invention, is described later in this application.

FIG. 3 shows a prior art female fitting, for use with the male fitting of FIG. 2. The female fitting 60 is also a substantially cylindrical metal body having a central through bore 61, for alignment with the bore 55 of the male fitting. At a proximal end 62 it has an interior chamber 66 as part of bore 61; the chamber sidewall has a full continuous thread 63 to engage the external male thread 53. A washer 6 is provided in the chamber 66, adjacent the end wall 67 of the chamber, against which the second end or nose 54 of the male fitting 50 seals when the male and female fittings are fully threaded (coupled). The female fitting has a connector 65 at its distal end 64 for connection to a nozzle or sprinkler or the like.

FIG. 4 shows a male coupling member or fitting in accordance with one embodiment of the present invention. The male coupling member 70 comprises a metallic body 71, which has a generally cylindrical shape. A through bore 72 extends along the longitudinal axis 73 of the body and has a generally smooth surface 74 intended to carry fluids such as water therethrough under pressure. A first end 75 of the male coupling member has a connector 76 intended to be permanently attached to the end of a hose or, alternatively, to constitute the end of a tap, faucet or spigot (here collecting a “spigot”). The outer surface 77 adjacent the second end 78 of the male coupling member has an interrupted thread 79. This thread 79 is intended to be threaded into a female coupling member (e.g. at the end of a hose, a nozzle or the like). The thread 79 has a plurality of individual thread portions, 79a, 79b, 79c, 79d . . . which are discontinuous. That is, instead of a conventional, continuous full thread as shown in FIGS. 1-3, these threads are discontinuous or interrupted at predetermined intervals around their circumference. Thus, interrupted portions or channels 80a, 80b, 80c . . . , which traverse all of the thread portions at that location, extend longitudinally along the generally cylindrical body of the male coupling member thereby interrupting each of the thread portions, at each such location. These interrupted portions create continuous longitudinal channels 80 whose function will be discussed in more detail below. The interruptions between the thread portions do not interfere with the primary function of these threads, namely, to connect to a corresponding female thread in a female coupling member to which the male coupling member is to be attached. The female coupling member preferably has a continuous thread.

On the other hand, the presence of these channels 80 has been found to have an extremely positive impact on the utility of these coupling members. It is believed that the channels create flow paths for water under pressure flowing within the coupling member and/or the hose to which it may be attached. Thus, if the first end 75 of a male coupling member 70 is attached to the end of a hose, and the second end 78 of the male coupling member having interrupted thread portions 79 and channels 80 is threaded onto a female member, such as member 60 having a continuous female thread, even with the water under pressure flowing within the hose, removal of the nozzle can now be facilitated. In contrast, with a prior art continuous thread on the male coupling member as shown in FIGS. 1-2, any attempt to unscrew the nozzle from the hose will result in a substantial spray of water, substantially in all directions, thus spraying liquid not only upon the individual attempting to remove the nozzle, but also onto anyone within a moderate distance therefrom. It has unexpectedly been discovered, however, that by utilizing the present invention, when the same nozzle is now being unscrewed from the hose, the pressurized water tends to flow within the channels 80, along the hose surface, thus avoiding the vigorous spray previously encountered thereby.

More specifically, with the interrupted thread portions 79 and channels 80 of the male coupling member, it has been found that the pressure-directed stream of water in the assembly causes a movable sealing member, such as washer 115 shown in FIG. 9, to unseat itself from an end surface 251 of an interior chamber 252 of a female coupling member 250 (having a full thread) and to be forced against the end surface 81 of the male coupling member 70, closing the channels 80, and thus maintaining the seal within the connection, even while the male coupling member is being unscrewed from the female coupling member. Just prior to complete release of the male coupling member, however, the reduced pressure therein will allow the movable sealing member 115 to separate from the second end surface 81 of the male coupling member and return to the inner chamber 252 of the female coupling member.

Use of the interrupted threads may also render decoupling of the male and female members far easier than has been the case in the past. Thus, hand separating or decoupling can be more readily affected. Alternative known gripping portions can also be included thereon to facilitate such hand gripping.

In order to illustrate the controlled release phenomenon and to contrast the prior art, reference is made to FIGS. 8-9. There was previously described a conventional (prior art) full thread coupling between a male coupling member 50 attached to the end of a hose (FIG. 2), and a female coupling member 60 attached to a nozzle (FIG. 3) This conventional coupling is shown schematically in FIG. 8A, wherein a standard continuous male thread 53 on the male coupling member 50 engages a continuous female coupling thread 63 on the female coupling member 60. When these threads are fully engaged as shown in FIG. 8A, a seal is created between the two coupling members by the threads, and the pressurized water flows through the hose in the direction of the arrow 5 to the nozzle. The seal between the coupling members 50/60 is further enhanced by the washer 6 located between the end 54 of male member 50 and the end wall 67 of chamber 66 in the female member 60.

Turning to FIG. 8B, effecting removal of the male coupling member 50 from the female coupling member 60 is carried out by rotating the male coupling member so that the threads 53 and 63 begin to disengage. These full standard threads maintain sufficient pressure so that the washer 6 is still trapped by approximately equal pressures on both sides, thus limiting the potential for movement of the washer 6. With the seal thus broken by uncoupling the threads, fluid pressure between the male and female coupling members is released in a chaotic uncontrolled pattern around the perimeter of the threads. Further, the point of release of pressure is constantly changing as components are rotated apart during such disassembly. As shown by arrows 7, the water under pressure within the hose sprays randomly in all directions from the point of disassembly.

FIG. 9 demonstrates the same disassembly operation, but now in connection with the coupling assembly of the present invention, including interrupted thread portions 79 and channels 80 on the male coupling member 70. In the completely threaded configuration shown in FIG. 9A, a movable sealing member, here washer 115, is located between distal end surface 81 of male member 70 and end wall 251 of the chamber 252 in female member 250, forming a complete seal blocking the channels 80. The pressure (illustrated by arrow 8) dead heads in the assembly. However, as one begins to disengage the male coupling member 70 from the female coupling member 250, (as shown in FIG. 9B), there is a fast pressure relief and fluid flow (in the direction of arrow 8) due to the channels 80. This allows for a controlled or directional relief of pressure and fluid from the coupling assembly. The washer 115 reacts to the flow and to the pressure differential created by the channels 80 by moving off of end wall 201.

During an initial rotation (uncoupling) of the threaded male and female members as illustrated in FIG. 9B, fluid and pressure are moving around the perimeter of the washer 115 (see arrows 9), allowing it to move off of the inner end wall surface 251 of the interior chamber 252. Turning to FIG. 9C, the washer 115 is thereafter forced into contact with the end face 81 of the male coupling member 70, re-forming the seal and creating a temporary seal of the channels 80 during subsequent rotation of the coupling members. Thus, leakage can be kept to a minimum during the disassembly process, and in any event as discussed above, whatever leakage does occur is channeled to direct the flow of water in a controlled manner so as to not be sprayed uncontrollably in all directions as is the case with the conventional system of FIGS. 2 and 8.

As discussed above, the first end 75 of the male coupling member 70 can be attached to the end of a hose 40. This is normally carried out by pinching the hose material between the coupling components with the use of a cylindrical outer sleeve called a ferrule. The two most popular forms of doing so are by expanding the tail of the male outwardly and squeezing the hose material into the inner surface of the ferrule, the ferrule in this case containing radial ribs to help facilitate gripping of the hose and restraining it from pulling out of the assembly, or secondly a connection can be made by an external crimp which crushes a smooth version of the ferrule down and pinches the hose onto a male tail that has similar barbed geometry to help engage the hose material. Again, these types of connections are conventional in this art.

On the other hand, the male coupling member 70 can itself constitute the end of a tap or nozzle. Thus, any male fitting that seals on its nose or leading surface (i.e. end 78) against a washer can utilize this invention.

Referring next to FIG. 5, in an alternative embodiment the female coupling member has interrupted threads and channels. However, in this case the washer would not be movable in the interior chamber of the female coupling member (it would be blocked from moving by the female threads). Thus, there would continue to be some liquid released from the assembly, albert in a controlled manner which would still be an improvement over the prior art. The female coupling member with interrupted threads and channels can be manufactured, as the male coupling member, by an improved process described below providing significant material savings.

In FIG. 5, female coupling member 90 includes a generally cylindrical body 91 having a longitudinal through bore 92 (along axis 93) with a generally smooth inner surface 94. Adjacent end 95 is a connector 96 for a nozzle, sprinkler or other type of fitting adjacent the opposing end 98 is a cylindrical inner chamber 102 having a sidewall with an interrupted thread 99, for engagement with an interrupted male thread 79 of a corresponding male coupling member. Each of the plurality of female thread portions 99a, 99b, 99c . . . , is interrupted by channels 100 extending longitudinally along the inner sidewall surface of the chamber 102; the chamber forms one part of bore 92 adjacent the first end 98 of the female coupling member 90. Thus, a plurality of channels 100a, 100b, 100c . . . extend longitudinally within the inner sidewall surface of the chamber in female coupling member adjacent the first end 98. A washer 115 is provided adjacent end wall 101 of chamber 102 to seal against the second end surface 81 of the male coupling member (as shown in FIG. 9A). The channels 100 created by the interrupted thread portions 99 in the female coupling member provide the same initial pressure and controlled liquid release discussed in reference to FIG. 9B.

Another advantage of providing a coupling member with the interrupted threads and channels, as compared to a conventional coupling member with a continuous thread, is that the interrupted thread portions of the present invention require a significantly reduced amount of total material or metal. Indeed, a reduction of from about 20% to 45% in total material costs in production of these coupling members, such as a reduction of from about 20% to 25%, but preferably from a 30% to 45% reduction, can be realized thereby. When this cost reduction is evaluated in conjunction with the various advantages of the present invention as discussed above, it can be seen that a highly significant improvement in this field has now been created.

In order to produce coupling members with interrupted threads according to one embodiment of the present invention, the generally cylindrical body of the coupling member is produced by an extrusion process in which a metal such as brass is extruded through a die to produce these members. Applicants have found that it is possible to produce these coupling members with the interrupted threads and still utilize the extrusion process therefore. The extrusion process itself is one where a larger piece of material is forced through a smaller opening under very high pressures and sometimes elevated temperatures. Doing so thus forces the material to flow through the orifice, and the material takes on the shape of the orifice through which it is pushed. With the use of additional tools and mandrels in this type of process, hollow shapes can also be created, given the proper material conditions. Again, the extrusion techniques that can be utilized in this method embodiment are conventional.

FIG. 10 illustrates one method embodiment wherein a splined bar 301, having alternating grooves 302 and projections 303 extending axially (longitudinally) along the length of the bar 305, is used as a starting component. This splined bar may be made by extruding a generally cylindrical bar 300, through a star (spline) shaped extrusion die, (e.g., of the shape shown in FIG. 4C), to produce a splined bar having the cross section shown in FIG. 4C. In the FIG. 4C embodiment, the spline or star shape includes eight radial grooves 121 alternating with eight radial projections 122. This spline shape serves as a useful hand grip 83, which may enable hand tightening of the male and female fittings, without requiring the use of tools.

Returning to FIG. 10, the extruded splined bar 301 is then cut transversely into a plurality of components 306a, b, c . . . , each of which is later machined or milled to form the transverse spacing between the interrupted thread portions, transverse to the already existing channels formed by grooves 302, in the coupling members 307a, 307b . . . . In this manner, the channels 80 on the male fitting are those same grooves 302 in the splined bar, and do not need to be formed by subsequent machining or milling (as in the prior art). As, a result, less material is used, namely the material lost by machining or milling in the prior art.

FIGS. 6-7 illustrate alternative embodiments of fittings and methods of manufacture. FIG. 6A is a cross section of a external spline shaped bar 200, having alternating grooves 201 and projections 202, for making a male fitting (similar to the bar in FIG. 4C and male fitting in FIG. 4A). Alternatively, in a next step or during the same step of forming the extruded bar 200 with an external spline shape, an internal spline shaped bore 203 is formed, having internal grooves 204 alternating with projections 205. This bar 210, with both internal and external splines, may be used to manufacture the female fitting shown in FIG. 5 (see e.g. the cross section of FIG. 5C). As another alternative, a bar 220 is shown in FIG. 7 having a substantially cylindrical outer surface 221 and a splined interior bore 222 with alternating grooves 223 and projections 224 (similar to the interior bore in FIG. 6B).

Alternatively, one can extrude these coupling members with a continuous thread, and then machine that product in order to produce the interrupted thread portions of the present invention. This would not achieve the same material savings as described previously. The specific methods of machining or milling to produce the interrupted thread portions are well known in this art.

Although the invention herein has been described with reference to particular embodiments, it is to be understood that these embodiments are merely illustrative and that numerous modifications may be made to the illustrative embodiments and that other arrangements may be devised without departing from the scope of the present invention as defined by the appended claims.

1. A hose coupling assembly comprising:
a generally cylindrical male fitting having a first end connector for attachment to a garden-type hose or spigot and a second end connector having a plurality of interrupted, male thread portions for attachment to a female fitting, a plurality of longitudinally disposed channels each extending across the plurality of male thread portions;
a female fitting having a female thread disposed within a chamber adjacent a first end of the female fitting for coupling to the second end connector of the male fitting, the chamber having an end wall;
a movable sealing member sized to fit between the second end of the male fitting and the end wall of the female fitting and extend across the channels;
an aligned central longitudinal bore in the male and female fittings and sealing member to allow a pressurized liquid to flow through the bore;
wherein the sealing member is movable between positions:
a first position engaging both the end wall of the female fitting and second end of the male fitting to seal the assembly against leakage of the pressurized liquid when the male and female fittings are fully coupled;
a second position spaced from each of the end wall and second end upon initial decoupling of the male and female fittings, wherein the pressurized liquid can flow into the channels to reduce the pressure of the liquid in the assembly; and
a third position spaced from the end wall and engaging the second end of the male fitting to seal the channels against flow of the pressurized liquid during subsequent decoupling.

2. The assembly of claim 1, wherein the female fitting comprises a nozzle, hose, sprinkler or spigot.

3. The assembly of claim 1, wherein the garden-type hose is a water hose for residential or commercial use operating at pressures of a municipal water line.

4. The assembly of claim 3, wherein the pressure comprises 30 to 60 pounds per square inch.

5. The assembly of claim 3, wherein the hose has a diameter of ⅜ to one inch.

6. The assembly of claim 1, wherein the male fitting is made of metal.

7. The assembly of claim 6, wherein the metal is brass or aluminum.

8. The assembly of claim 1, wherein the male and female fittings are each independently made of metal or plastic.

9. The assembly of claim 1, wherein the male and female fittings are both made of metal.

10. The assembly of claim 9, wherein the metal is brass.

11. The assembly of claim 1, wherein the movable sealing member comprises a resilient plastic or rubber type compound.

12. A coupling assembly comprising:
male and female fittings having an aligned longitudinal bore for conveying a pressurized liquid,
the fittings having male and female threads respectively, the male thread having interrupted thread portions and longitudinal channels extending across the thread portions;
a movable sealing member closing the channels when the fittings are fully coupled;
the sealing member being movable during an initial decoupling to open the channels for a partial pressure relief and flow of the liquid into the channels; and
subsequent to the initial decoupling, the sealing member being movable to a further resealing position closing the channels to block the flow of the liquid during further decoupling.

13. The coupling assembly of claim 12, wherein the fittings are adapted for one or more of a plumbing, water heater, propane or natural gas tank, fuel system or coolant system.

14. The coupling assembly of claim 12, wherein the fittings are adapted for conveyance of a pressurized liquid at up to about 80 pounds per square inch of pressure.

15. The coupling assembly of claim 14, wherein the pressure is about 30 to 60 pounds per square inch.

16. The coupling assembly of claim 12, wherein the fittings are garden hose type fittings.

17. A method of making a fitting comprising:
providing a generally cylindrical bar having a longitudinal axis for forming a plurality of fittings;
extruding the bar through a splined extrusion die to form a splined bar having longitudinal projections separated by longitudinal channels;
forming a plurality of fittings from the splined bar including steps of, in either order:
cutting the bar transverse to its length to form the plurality of fittings;
machining or milling a plurality of interrupted thread portions adjacent one end of each fitting, wherein the channels of the splined bar comprise longitudinally disposed channels extending across the plurality of thread portions.

18. The method of claim 17, wherein the bar comprises metal or plastic.

19. The method of claim 18, wherein the bar comprises brass or aluminum.

20. The method of claim 17, wherein the bar comprises a solid cylindrical bar and the method further comprises the step of forming a central longitudinal bore in the bar.

21. The method of claim 20, wherein the central longitudinal bore is formed during the extrusion step.

22. The method of claim 17, wherein the bar has a central longitudinal bore.

23. The method of claim 17, wherein the fitting comprises a coupling member for a tube conducting a pressurized liquid.

24. The method of claim 23, wherein the tube conveys a liquid at up to about 80 pounds per square inch of pressure.

25. The method of claim 23, wherein the tube conveys a liquid at a pressure of a municipal water line.

26. The method of claim 23, wherein the pressure is about 30 to 60 pounds per square inch.

27. The method of claim 17, wherein the fitting comprises a metallic fitting for a garden-type hose, nozzle, sprinkler or spigot.

28. The method of claim 27, wherein the hose has a diameter in the range of ⅜ to one inch.

29. The method of claim 17, wherein the fitting comprises a gas grill fitting or a plumbing fitting.

30. The method of claim 17, wherein the fitting comprises a sink fitting, a toilet fitting or a hot water heater fitting.

31. The method of claim 17, wherein the fitting comprises a male or female fitting.

32. The method of claim 17, wherein the fitting comprises a male fitting.
